(19) United States
(12) Patent Application Publication
(10) Pub. No.: US 2007/0290926 A1
(43) Pub. Date: Dec. 20, 2007

(54) Ultra wide bandwidth planar antenna

(75) Inventor: Kuo-Hua Tseng, Mei-Nung Chen (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: Universal Scientific Industrial Co., Ltd., Tsao-Tun Chen (TW)

(21) Appl. No.: 11/452,988

(22) Filed: Jun. 15, 2006

(51) Int. Cl. H01Q 1/38

(52) U.S. Cl. 343/700 MS

(57) ABSTRACT

A planar antenna, which is operable within the ultra wide bandwidth, includes a dielectric substrate, a radiating element, a feeding element, and a grounding element. The dielectric substrate has opposite first and second surfaces. The radiating element is formed on the first surface of the dielectric substrate, and includes a tapered part. The tapered part has a converged end portion, and a pair of jagged sides that diverge from the converged end portion. The feeding element is formed on the first surface of the dielectric substrate, and extends from the converged end portion of the tapered part of the radiating element. The grounding element is formed on the second surface of the dielectric substrate.

### BACKGROUND OF THE INVENTION

1. Field of the Invention

This invention relates to a planar antenna, more particularly to an ultra wide bandwidth planar antenna.

2. Description of the Related Art

In U.S. Pat. No. 6,914,573, there is disclosed a conventional planar antenna that is operable within the ultra wide bandwidth (UWB), i.e., between 3.1 GHz and 10.6 GHz. The conventional planar antenna includes a radiating element, a feeding strip that extends from the radiating element, and a grounding element that is disposed around the radiating element.

The aforementioned conventional planar antenna is disadvantageous in that, when operated within the UWB, it has an unsatisfactory voltage standing wave ratio (VSWR) of greater than three.

### SUMMARY OF THE INVENTION

Therefore, the object of the present invention is to provide a planar antenna that can overcome the aforesaid drawback of the prior art.

According to the present invention, a planar antenna, which is operable within the ultra wide bandwidth, comprises a dielectric substrate, a radiating element, a feeding element, and a grounding element. The dielectric substrate has opposite first and second surfaces. The radiating element is formed on the first surface of the dielectric substrate, and includes a tapered part. The tapered part has a converged end portion, and a pair of jagged sides that diverge from the converged end portion. The feeding element is formed on the first surface of the dielectric substrate, and extends from the converged end portion of the tapered part of the radiating element. The grounding element is formed on the second surface of the dielectric substrate.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of a planar antenna according to the present invention;

FIG. 2 is a plot illustrating a voltage standing wave ratio of the preferred embodiment;

FIG. 3 is a plot illustrating a radiation pattern of the preferred embodiment on the x-y plane when operated at 3.1 GHz;

FIG. 4 is a plot illustrating a radiation pattern of the preferred embodiment on the x-y plane when operated at 5 GHz; and

FIG. 5 is a plot illustrating a radiation pattern of the preferred embodiment on the x-y plane when operated at 2.4 GHz.

### DETAILED DESCRIPTION OF THE PREFERRED EMBODIMENT

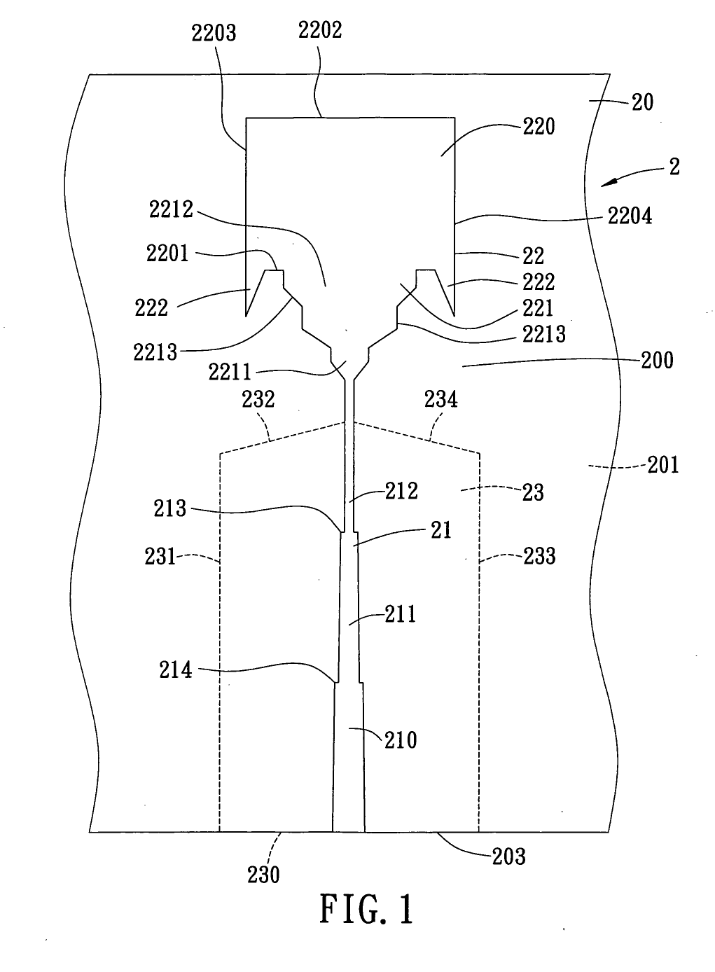

Referring to FIG. 1, the preferred embodiment of a planar antenna 2 according to this invention is shown to include a dielectric substrate 20, a radiating element 22, a feeding element 21, and a grounding element 23.

The planar antenna 2 of this embodiment is operable within the ultra wide band (UWB), i.e., between 3.1 GHz and 10.8 GHz.

The dielectric substrate 20 has an edge 203, and opposite first and second surfaces 200, 201. In this embodiment, the dielectric substrate 20 is available from Rogers Corp. under model no. RO4003C. In an alternative embodiment, the dielectric substrate 20 is a FR-4 substrate.

The radiating element 22 is formed on the first surface 200 of the dielectric substrate 20, and includes first and second parts 221, 220, and a pair of pointed protrusions 222.

The first part 221 of the radiating element 22 includes opposite converged and diverged end portions 2211, 2212, and a pair of jagged sides 2213 that diverge from the converged end portion 2211 to the diverged end portion 2212 of the first part 221 of the radiating element 22. That is, the first part 221 of the radiating element 22 is tapered from the diverged end portion 2212 to the converged end portion 2211 thereof.

The second part 220 of the radiating element 22 is generally rectangular in shape, and has opposite first and second sides 2201, 2202, and opposite third and fourth sides 2203, 2204. The diverged end portion 2212 of the first part 221 of the radiating element 22 extends from the first side 2201 of the second part 220 of the radiating element 22.

Each of the protrusions 222 is triangular in shape, and extends transversely from a respective one of opposite ends of the first side 2201 of the second part 220 of the radiating element 22. The diverged end portion 2212 of the first part 221 of the radiating element 22 is disposed between the protrusions 222.

The feeding element 21 is formed on the first surface 200 of the dielectric substrate 20, is in the form of a strip, and has first, second, and intermediate sections 212, 210, 211. The first section 212 of the feeding element 21 extends from the converged end portion 2211 of the first part 221 of the radiating element 22. The second section 210 of the feeding element 21 is opposite to the first section 212 of the feeding element 21 and has an end that is flush with the edge 203 of the dielectric substrate 20. The intermediate section 211 of the feeding element 21 interconnects the first and second sections 212, 210 of the feeding element 21. In this embodiment, the feeding element 21 has a width that is progressively increased from the first section 212 to the second section 210 thereof for impedance matching purposes. Accordingly, a first shoulder 213 is formed at a junction of the first and intermediate sections 212, 211 of the feeding element 21, and a second shoulder 214 is formed at a junction of the intermediate and second sections 211, 210 of the feeding element 21.

The grounding element 23 is formed on the second surface 201 of the dielectric substrate 20, and has a length that is shorter than that of the feeding element 21. In this embodiment, the grounding element 23 is generally pentagonal in shape, and has a first side 230 that is flush with the edge 203 of the dielectric substrate 20, parallel second and third sides 231, 233, each of which extends transversely from the edge 203 of the dielectric substrate 20, and fourth and fifth sides 232, 234.

It is noted that the radiating element 22 and the feeding element 21 are formed by patterning and etching a first copper foil provided on the first surface 200 of the dielectric substrate 20. Similarly, the grounding element 23 is formed by patterning and etching a second copper foil provided on the second surface 201 of the dielectric substrate 20.

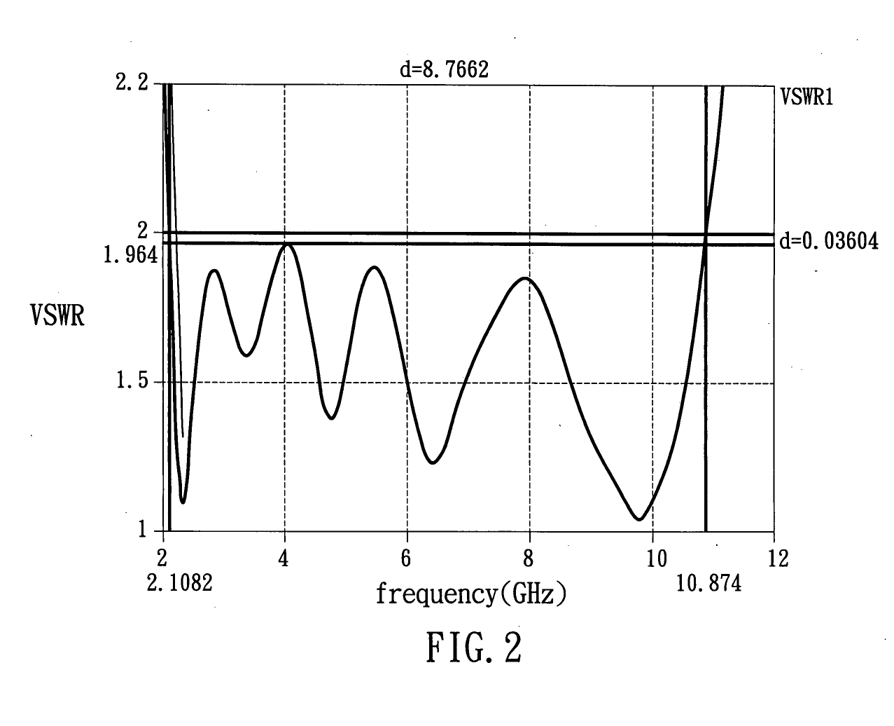

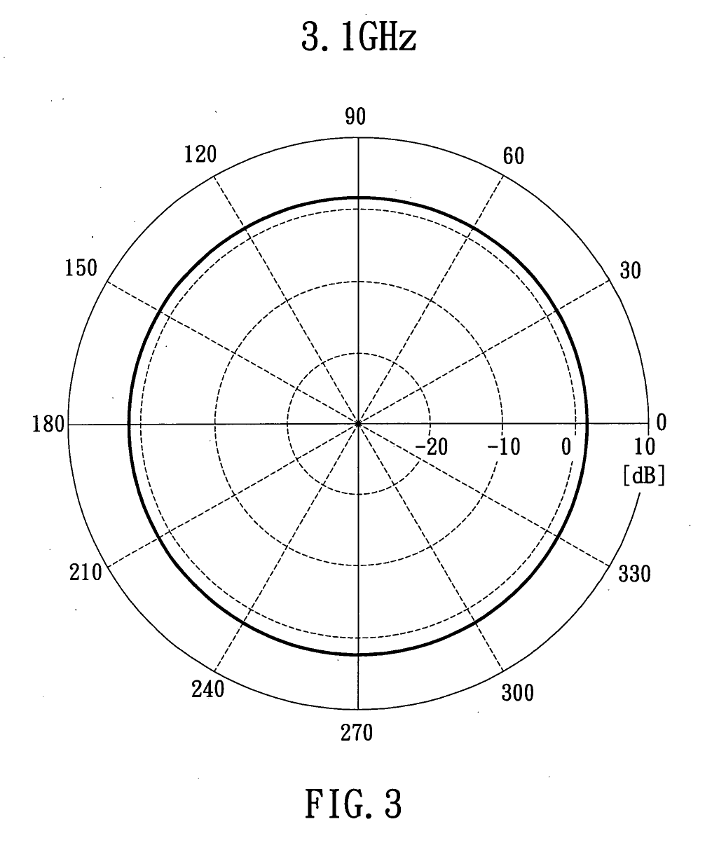

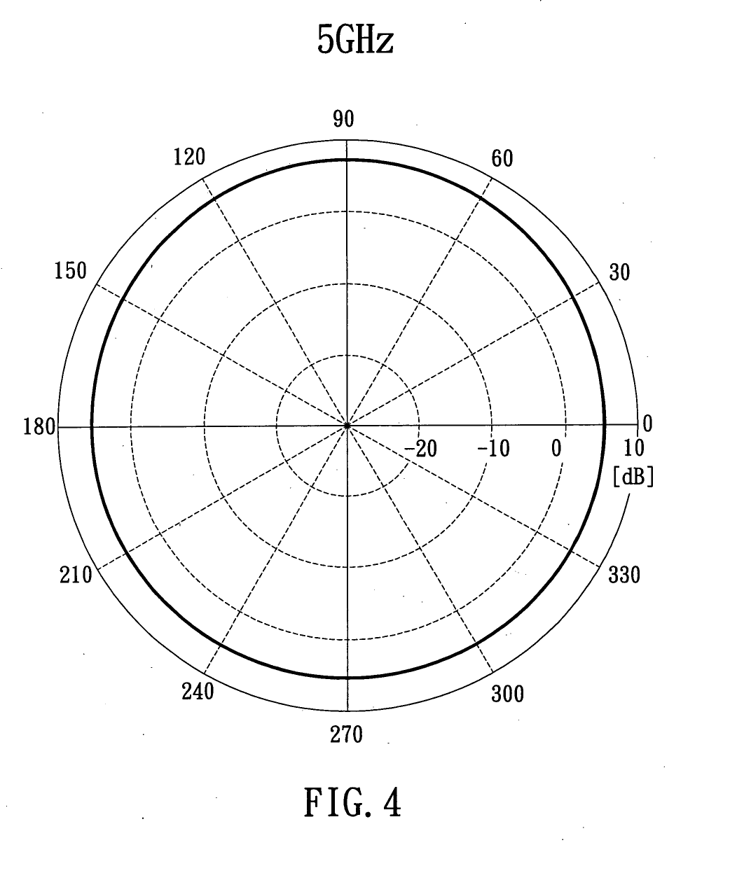

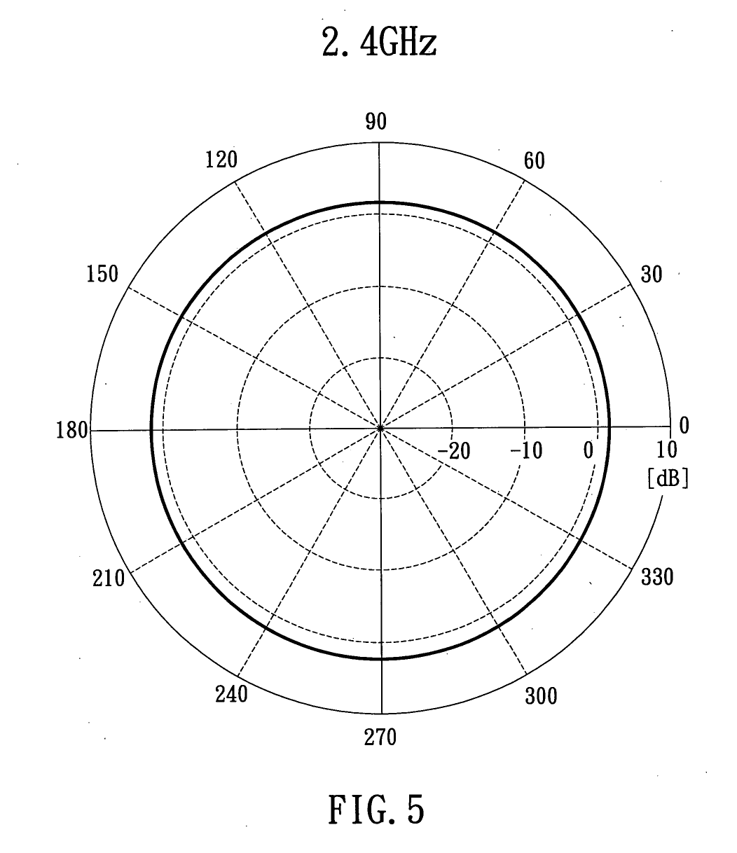

Based on simulation results, as illustrated in FIG. 2, the planar antenna 2 of this invention, when operated within 2.1082 GHz and 10.874 GHz, achieves a voltage standing wave ratio (VSWR) of less than 1.964. Moreover, as illustrated in FIGS. 3 and 4, the planar antenna 2 of this invention, when operated at 3.1 GHz and 5 GHz, has radiation patterns that are omni-directional. Further, as illustrated in FIG. 5, the planar antenna 2 of this invention, when operated at 2.4 GHz, which is outside the UWB, has a radiation pattern that is omni-directional. Hence, the planar antenna 2 of this invention is indeed applicable to devices that operate in the UWB, and as well as to devices that operate in 2.4 GHz, such as bluetooth-compliant and WiFi-compliant devices.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A planar antenna operable within the ultra wide bandwidth, comprising:
a dielectric substrate having opposite first and second surfaces;
a radiating element formed on said first surface of said dielectric substrate, and including a tapered first part that has a converged end portion, and a pair of jagged sides diverging from said converged end portion;
a feeding element formed on said first surface of said dielectric substrate, and extending from said converged end portion of said tapered first part of said radiating element; and
a grounding element formed on said second surface of said dielectric substrate.

2. The planar antenna as claimed in claim 1, wherein said radiating element further includes a non-tapered second part that has a side, said first part further has a diverged end portion that is opposite to said converged end portion and that extends from said side of said second part, said first part being tapered from said diverged end portion to said converged end portion.

3. The planar antenna as claimed in claim 2, wherein said second part is generally rectangular in shape.

4. The planar antenna as claimed in claim 2, wherein said side of said second part has opposite ends, said radiating element further including a pair of protrusions, each of which extends transversely from a respective one of said opposite ends of said side of said second part, said diverged end portion of said first part being disposed between said protrusions.

5. The planar antenna as claimed in claim 1, wherein said dielectric substrate further has an edge, said feeding element having opposite first and second end sections, said first end section of said feeding element extending from said converged end portion of said first part, said second end section of said feeding element having an end that is flush with said edge of said dielectric substrate.

6. The planar antenna as claimed in claim 5, wherein said feeding element is in the form of a strip, and has a width that is progressively increased from said first end portion to said second end portion thereof.

7. The planar antenna as claimed in claim 5, wherein said feeding element further has an intermediate section that interconnects said first and second end section thereof, a first shoulder that is formed at a junction of said first and intermediate sections, and a second shoulder that is formed at a junction of said intermediate and second sections.

8. The planar antenna as claimed in claim 1, wherein said grounding element is generally pentagonal in shape.

9. The planar antenna as claimed in claim 8, wherein said dielectric substrate has an edge, said grounding element having a first side that is flush with said edge of said dielectric substrate, and parallel second and third sides, each of which extends transversely from said edge of said dielectric substrate.

10. The planar antenna as claimed in claim 1, wherein said grounding element has a length that is shorter than that of said feeding element.
